(19) United States
(12) Patent Application Publication
(10) Pub. No.: US 2003/0124281 A1
(43) Pub. Date: Jul. 3, 2003

(54) Liquid-or vapor-conducting system with a jointing zone made from a coextruded multilayer composite

(75) Inventors: Hans Ries, Marl (DE); Sylvia Monsheimer, Haltern (DE); Rainer Goering, Borken (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/329,531

(22) Filed: Dec. 27, 2002

(30) Foreign Application Priority Data
Dec. 28, 2001 (DE) 101 64 408.6

(51) Int. Cl. B32B 1/08; B65D 1/00

(52) U.S. Cl. 428/35.7; 428/36.91; 428/36.9

(57) ABSTRACT

The present invention relates to a liquid or vapor conducting system containing an attachment cohesively bonded to a hollow article by way of a coextruded multilayer composite and a method for bonding single- or multilayer hollow plastic articles to attachments. Within the present invention the attachments include: attachment nipples, threaded necks, closure caps, and valves; and the bond is made with the aid of a semifinished or finished product produced from a coextrudate.

### CROSS REFERENCE TO RELATED CASES

The present application claims priority to German Application No. DE 101 64 408.6, filed on Dec. 28, 2001, which is hereby incorporated by reference in its entirety.

### BACKGROUND OF THE INVENTION

1. Field of the Invention

The present invention relates to a liquid or vapor conducting system containing an attachment cohesively bonded to a hollow article by way of a coextruded multilayer composite and a method for bonding single- or multilayer hollow plastic articles to attachments. Within the present invention the attachments include: attachment nipples, threaded necks, closure caps, and valves; and the bond is made with the aid of a semifinished or finished product produced from a coextrudate.

2. Discussion of the Background

The most common method of producing hollow plastic articles is blow molding, including suction blow molding or extrusion. However, it is also possible for a hollow body to be welded together from extruded sheets, which have been previously thermoformed. Examples of other known hollow articles are those made by injection molding or by rotational sintering from polyamides. Tubes may also be produced by conventional extrusion methods using a tube calibrator or sheet calibrator, or by using molding blocks (corrugated-tube take-off principle), to provide the ends with closure caps, and thus likewise produce a container.

Irrespective of what method of production is employed, the container generally has to be provided with threaded connections (i.e., a pouring neck or a filling neck) and openings, or with nipples to connect lines. This is particularly true for fuel tanks, which require welding various valves in addition to attachment nipples for lines and tank-filling necks. Pipelines also require the attachment of branches, valves, or caps.

One of the most pronounced problems arises when hollow articles contain polyethylene as main component in a single- or multilayer wall. One aspect of this problem is that durable leakproofing of threaded closures or bayonet closures using conventional technology (i.e., screw closure and rubber gasket) is difficult to achieve since polyethylene is very susceptible to creep. The problem is exacerbated if the liquids to be stored or conveyed (such as crop-protection compositions, solvents, fuels, or oils) solvate the wall or components connected thereto, or if the materials can undergo cycles of expansion or shrinkage due to temperature changes. In this scenario it is advantageous for the corresponding attachment to be composed of a hard material which does not creep and, where appropriate, also undergoes little or absolutely no swelling, and for this to have been welded onto the container wall or tube wall, or to have been connected thereto by sheathing in an injection or blowing process. However, this “solution” results in additional problems such as compatibility of the materials that are in direct contact with one another and are to be connected to one another, since poor compatibility compromises the durability and leakproofness.

In the case of a plastic fuel tank, another problem arises. In the light of the ever more stringent requirements placed upon the reduction of hydrocarbon emissions from motor vehicles, the design of these tanks is primarily multilayer. These tanks are produced with up to 6 layers, with one of these layers being a layer with substantially higher barrier action with respect to the permeation of fuel components. However, openings cut in the shell of the tank in order to attach add-on components by welding give rise to a point of weakness with respect to the permeation of fuel components. If the material of the attachments to be welded onto the openings is the same as that of the tank cap, generally polyethylene, permeation at these locations is higher than at other locations on the multilayer composite.

The main prior art to date consists in the welding-on of nipples, attachments, and valves or valve covers which are composed entirely of polyethylene and do not have any separate barrier layer. A tank manufactured in this way is now incapable of reliably complying with the ever more stringent requirements, e.g. those known as “LEV-II” and “P-ZEV” from the future CARB emission-protection legislation in the USA.

Alongside low-permeation protective covering of the apertures, another factor that is proving problematic is the connection of lines to a plastic fuel tank, since leaks can rapidly arise between the welded-on polyethylene nipples and the pipelines connected thereto, because polyethylene is susceptible to creep. The use of what are known as “quick connectors” for useful low-cost connection between nipple and pipeline is not possible, since the pressure associated with the O-ring gaskets causes the polyethylene to creep, thereby resulting in unacceptable leaks. Similar considerations apply to the connection of tank filler neck and tank. For this reason, connections of this type are generally executed with the aid of short elastomer hoses and hose clamps. Although the use of elastomer hoses can eliminate leakage, the hoses themselves are a point of weakness, since to a large extent they are permeable to hydrocarbons. Moreover, hoses made from fluoroelastomers with very good barrier properties are extremely expensive. In addition, the connection of a polyethylene nipple or polyethylene neck to a non-creeping attachment, e.g. one made from glassfiber-reinforced polyamide, by means of a rubber hose is complicated to produce and expensive. Accordingly, a critical need exists to replace the aforementioned “solutions” with lower-cost and better systems.

Glassfiber-reinforced molding compositions have been attempted, as a direct design of the nipple should to eliminate creep. However, there are no reinforced polyethylene grades suitable for this purpose, much less polyethylene grades that are able to withstand the other mechanical requirements placed upon the connection. Furthermore, the strength of a welded connection between a fiber-filled and an unfilled polymer is inadequate. Therefore, a critical need also remains to find components which on the one hand can be bonded cohesively to the tank material and on the other hand have better properties in relation to barrier action and creep susceptibility than polyethylene, for example.

DE-C 42 39 909 discloses a connection that attempts to solve these problems. In this disclosure, a tube-like neck made from a material A, which is susceptible to creep, sheathed by an injection process on one side with a second material B, which has low susceptibility to creep. In the region of contact between the two materials, the tube-like structure has an AB layer structure.

However, this connection technique has not proven successful in practical trials. Specifically, the material A swells markedly on contact with fuel. Since the material B prevents swelling toward one side, the material swells and creeps in the other directions, the result being that after a period there is a risk firstly to force transmission and secondly to the integrity of the connection. This phenomenon becomes even more marked under mechanical load and/or if this tube-type neck becomes dry. The proposed modification of one of the two materials to achieve adhesion between the two molding compositions used actually exacerbates the situation, since the modified material (generally polyethylene) swells even more markedly and, in addition, the modification markedly impairs barrier action.

DE-C 195 35 413 describes a method of producing a connection unit from two materials A and B. In this connection unit the materials A and B interlock. At the same time, there is an adhesion-promoting molding composition embedded between A and B and additionally providing a cohesive bond. The less creep-susceptible material B can be welded onto a container whose outer skin is composed of a material compatible with, and weldable to, B.

In the development of this component it has become apparent that the compatibility of the two materials, and at the same time the achievement of weldability to the tank material, is a problem that is difficult to solve. The result being that only a few suitable combinations of materials can be developed, at high cost. Secondly, such an injection-molded element is generally restricted to a connection between two, or in exceptional cases between three, different molding compositions. The primary reason for this restriction is that if the bond between the materials is to be an intimate chemical bond which can therefore be subjected to load, they have to be processed “melt into melt” by coinjection processes. Elements made from three or more materials generally have to be produced via multistage processes in which in each case a melt is injected onto a component, which has previously solidified (the overmolding process). The first factor here is that the bond strength is generally markedly poorer than with melt-into-melt processing. The second factor is that an excessive number of expensive production steps are required if three or more materials have to be applied to one another.

Another problem in the case of the abovementioned attachments arises due to the fact that the welding of a multicomponent element that has a polyethylene-welding flange onto the polyethylene outer skin of the tank leaves a relatively thick intermediate layer of polyethylene between the barrier layer of the tank and the barrier skin of the element. The fuel constituents can then diffuse through this intermediate layer between the welding flange and the barrier layer, parallel to the surface, and can then be emitted past the attachment into the atmosphere. It would be advantageous here if the barrier component of the attachment or of the valve cover could be brought as close as possible to the barrier layer, thereby minimizing the passage area available for diffusion. However, this is subject to narrow limits, firstly since reasons associated with injection-molding technology prevent the thickness of the weldable flange component from being reduced as desired. Secondly, conventional welding processes, for example hot-plate welding, cannot displace the desired large amount of melt in order to reduce the thickness of the intermediate layer. Narrow limits are set here by the welding pressure available, the flexibility of the tank shell and the rate of solidification of the molding composition available.

Accordingly, there remains a critical need for low-cost, creep-resistant liquid or vapor conducting systems.

### SUMMARY OF THE INVENTION

Accordingly, it is an object of the present invention to provide a method for producing appropriate bonds in which the abovementioned problems are eliminated by way of a suitable geometric shape of the transition region between a hollow article, the outer surface of the jacket of which is composed of a material A, and a second component to be connected thereto and comprising at least one layer made from the material B.

In particular, an object of the present invention is a method of achieving this bond in such a way as to permit utilization of a wide variety of very different combinations of materials.

Another object of the present invention is a liquid- or vapor-conducting system comprising:

I. an attachment,

II. a jointing zone made from a coextruded multilayer composite which comprising at least two layers,

III. a hollow article,

wherein components I., II., and III. are cohesively bonded to one another.

The above objects highlight certain aspects of the invention. Additional objects, aspects and embodiments of the invention are found in the following detailed description of the invention.

### BRIEF DESCRIPTION OF THE FIGURES

A more complete appreciation of the invention and many of the attendant advantages thereof will be readily obtained as the same becomes better understood by reference to the following Figures in conjunction with the detailed description below.

FIG. 1 shows an injection-molded attachment nipple (1) made from a glassfiber-filled polyamide, the nipple having been bonded to a coextruded film composed of a polyamide (2), of a functionalized polyethylene (3), and of a high-density polyethylene (HDPE) (4). The resultant element has been welded onto a single- or multilayer tank predominantly of HDPE (5).

FIG. 2 shows an injection-molded socket made from a polybutylene terephthalate (6), where a multilayer cone produced by means of a block take-off (corrugated tube technology) has been welded onto the collar of the socket. The layer structure of the cone is polybutylene terephthalate (7)/adhesion-promoter (8)/HDPE (9) (adhesion-promoter such as BYNEL® CXA 4157). It has been welded onto a multilayer fuel tank (10), which is shown here as having three layers but may also have the structure (from the inside to the outside) HDPE/adhesion-promoter/EVOH/adhesion-promoter/regrind/ HDPE.

FIG. 3 shows the connection of a threaded flange (11), e.g. for fastening the pump unit to the tank (12). The threaded flange may either, as shown here, be composed of an unreinforced or glassfiber-reinforced polybutylene terephthalate, or be composed of a polyamide, where appropriate fiber-reinforced. The structure of the coextrudate (7; 8; 9) corresponds to that in FIG. 2. (If the threaded flange is composed of polyamide, the layer (7) is also formed from polyamide.)

### DETAILED DESCRIPTION OF THE INVENTION

Unless specifically defined, all technical and scientific terms used herein have the same meaning as commonly understood by a skilled artisan.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

The present invention is based in part on the Inventor's surprising discovery that a low-cost, creep-resistant liquid or vapor conducting system can be achieved by employing a connection unit, which has the following components:

I. An attachment, and

II. a coextruded multilayer composite which is composed of at least two layers,

where components I. and II. are cohesively bonded to one another.

In a preferred embodiment of the present invention is a liquid- or vapor-conducting system which comprises the above connection unit which has been bonded, for example by means of welding or sheathing in an injection process, to the single- or multilayer hollow article.

In another embodiment of the present invention is a single- or multilayer hollow article that has been cohesively bonded to the coextruded multilayer composite or to the connection unit of the invention.

The attachment used according to the present invention may be composed of a molding composition, which is unreinforced, reinforced, or filled. Examples of reinforcing agents that may be used are glassfibers, carbon fibers, aramid fibers, or metal fibers. The molding composition may also have electrically conductive additives giving it antielectrostatic properties. Examples of polymers of which its polymer base may be composed are a polyamide, such as a polyphthalamide; nylon-4,6; nylon-6; nylon-6,6; nylon-6,12; nylon-10,12; nylon-12,12; nylon-11; or nylon-12; a polyester, such as polyethylene terephthalate, polybutylene terephthalate, polyethylene 2,6-naphthalate, or polybutylene 2,6-naphthalate; or a fluoropolymer, such as polyvinylidene fluoride. However, it is also possible to use any other polymer which has sufficient stiffness and resistance to the liquid or gaseous medium, for example a polyphenylene sulfide; a mixed aliphatic/aromatic polyamide, e.g. nylon-6,T/MPMDT; a polyamide blend, e.g. ULTRAMID® T or TROGAMID® BX (nylon-6-3,T/nylon-6,6 blend); or a aliphatic polyketone.

The attachment may either have a single-layer structure or be composed of 2, 3, 4, 5, or more layers. One of these layers may be a barrier layer with respect to the liquid or gaseous medium, or a layer with antielectrostatic properties.

Examples of suitable attachments are attachment nipples, threaded necks, closure caps, valves, bayonet closures, quick connectors, threaded flanges; but it is also possible to attach entire modules, e.g. activated carbon filters, expansion tanks, or filter housings.

The coextruded multilayer composite has at least one layer B that can be cohesively bonded to the attachment, and also has a layer A that can be bonded, likewise cohesively, to the hollow article. A precondition here is that the layers A and B can be cohesively bonded to one another by coextrusion. However, for cohesive bonding of layers A and B there are only a few known combinations available. One of the materials used here generally has to be modified, and this modification is often attended by impairment of performance characteristics (e.g. lower level of barrier action, higher swelling, poorer mechanical properties). The following are examples of a two-layer structure:

Polyamide (where appropriate here and in the following examples having an excess of amino end groups)/maleic-anhydride-functionalized polyethylene or polypropylene;

Polyamide/a polyester which has been adhesion-modified with the aid of a polymer bearing functional groups;

Polyamide/a polyester which has been adhesion-modified with the aid of di- or polyfunctional compounds, examples of the functional groups here being anhydride, epoxide, oxazoline, or isocyanate;

Polyamide/maleic-anhydride-functionalized fluoropolymer;

Polyamide/fluoropolymer adhesion-modified by adding a (meth)acrylate copolymer.

If an adhesion-promoter layer C is used between layers A and B, the materials of the layers A and B may be selected purely according to the functional requirement, e.g. with regard to barrier action, weldability, and mechanical properties. It is also possible to use more than one adhesion-promoter layer (C1, C2, etc.) in series so as to bond two layers A and B to one another, where only one adhesion-promoter layer C would not suffice to bond these layers directly to one another.

Another layer which may be present in the coextruded multilayer composite is a barrier layer with respect to diffusion of fuel and the like, for example one made from EVOH. In order to achieve ideal protection from permeation, the barrier layers of the coextruded multilayer composite and of the hollow article are preferably brought as close as possible to one another or, where possible, into contact.

An example of a structure which the coextruded multilayer composite may have is polyethylene/adhesion-promoter/EVOH/adhesion-promoter/polyamide or polyethylene/adhesion-promoter/PVDF/adhesion-promoter/polyamide. Other possible appropriate composites are those with polyesters, with polyacetals, with polyphthalamide, with polyphenylene sulfide, or with other layer materials.

The following publications disclose examples of the composition of coextruded multilayer composites which may be used according to the invention: EP-A-0 509 211, EP-A-0 569 683, EP-A-0 601 295, EP-A-0 618 390, EP-A-0 637 511, EP-A-0 649 739, EP-A-0 673 762, EP-A-0 686 797, EP-A-0 729 830, EP-A-0 878 509, EP-A-0 982 122, EP-A-1 031 411, EP-A-1 065 048, DE-A-100 64 333, DE-A-100 64 334, and DE-A-100 65 177, EP-A-0 777 578, EP-A-0 991 720, WO 200123796, U.S. Pat. No. 5,736,610, EP-A-0 791 153, EP-A-0 731 307, EP-A-0 731 308, DE-A-198 03 134, EP-A-0 428 833, DE-A-37 15 251, EP-A-0 912 330, EP-A-0 436 923, EP-A-0 925 913, U.S. Pat. No. 6,176,268, EP-A-0 635 108, FR-A-2 707 724, EP-A-1 118 807, and EP-A-1 002 980.

The coextruded multilayer composite is in particular composed of 3, 4, 5, 6, or more layers.

Depending on the nature of the connection to be achieved, the coextruded multilayer composite may be composed of a coextruded film or sheet, of a coextruded tube (where appropriate molded by means of molding jaws), or of a composite produced by coextrusion blow molding or coextrusion suction blow molding. Where appropriate, required sections are cut out or stamped out from this product. Further forming of the multilayer composite prior to bonding to the attachment or prior to bonding to the single- or multilayer hollow article is possible, if desired, for example via thermoforming; this may take place prior to or after any cutting out or stamping out.

An example of a hollow article is a container or a tube. Examples of these are plastic fuel tanks, containers for activated carbon filters, stilling reservoirs, filler necks, and pipelines, for example for fuel, brake fluid, hydraulic fluid, or coolant.

The connection of the coextruded multilayer composite to the hollow article may take place by means of conventional welding processes, or else by insertion into the mold used to produce the hollow article by means of blow molding or rotational sintering. The bonding in this case takes place via incipient melting of the composite surface facing toward the container material, in the presence of simultaneous chemical reaction in the interface, or in the presence of physical material compatibility. Bonding to the attachment then takes place via a weld between the attachment and the coextrusion composite jointed in advance to the hollow article.

On the other hand, it is also possible to begin by bonding the coextrusion composite to the attachment. This may be achieved using the technology for injection molding onto an insert, via insertion of the coextrusion composite into an injection mold and using the material of the attachment for injection molding onto the insert, or else by welding the coextrusion composite to the attachment. Subsequent bonding to the hollow article in turn takes place as described above via welding or via insertion into the mold.

By analogy with the procedure described here, it is also possible, for example, to joint branches or lugs onto tubes.

The hollow article may have a single-layer structure or be composed of 2, 3, 4, 5, 6, or more layers. It may in particular comprise a barrier layer and/or an antielectrostatic layer.

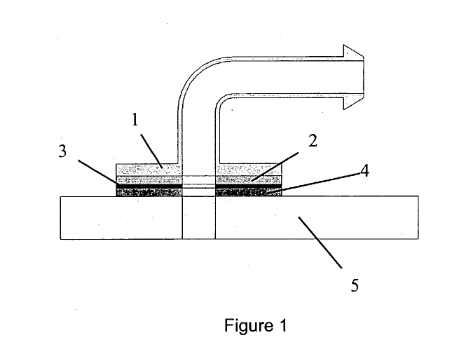

FIG. 1 shows an injection-molded attachment nipple (1) made from a glassfiber-filled polyamide, the nipple having been bonded to a coextruded film composed of a polyamide (2), of a functionalized polyethylene (3), and of a high-density polyethylene (HDPE) (4). The resultant element has been welded onto a single- or multilayer tank predominantly of HDPE (5).

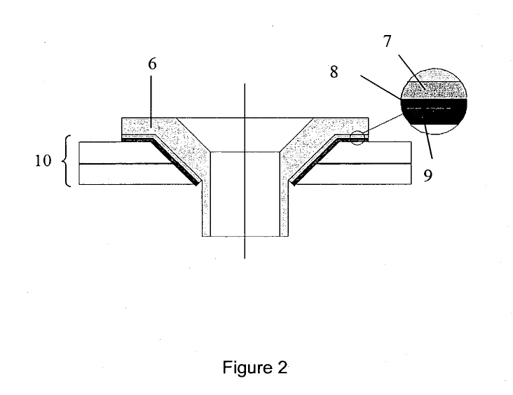

Another embodiment, as in FIG. 2, is given by an injection-molded socket made from a polybutylene terephthalate (6), where a multilayer cone produced by means of a block take-off (corrugated tube technology) has been welded onto the collar of the socket. The layer structure of the cone is polybutylene terephthalate (7)/adhesion-promoter (8)/HDPE (9) (adhesion-promoter such as BYNEL® CXA 4157). It has been welded onto a multilayer fuel tank (10), which is shown here as having three layers but may also have the structure (from the inside to the outside) HDPE/adhesion-promoter/EVOH/adhesion-promoter/regrind/HDPE. The regrind layer is typically made from the reground pinch-off scrap cuts from blow-molded parts during the manufacturing process. These multilayer tanks are prior art (e.g. Siewert, H., Thielen, M.: Trends beim Coextrusionblasformen [Trends in coextrusion blow molding], Kunststoffe 88 (1998) 8, pp. 1218 et seq.). By virtue of the conical design of the welding site, it is possible to reduce the gap between the EVOH barrier layer of the tank and the polybutylene terephthalate, which is likewise a very effective barrier with respect to fuels, when comparison is made with the previous weld design (as shown in FIG. 1), and the result is a reduction in permeation losses. Appropriate conical design of the coextruded component may also be achieved by thermoforming of coextruded sheets or films.

Depending on the further requirements relevant to the purpose of the connection, the design shown here for the socket may be varied. For example, additional elements, such as O-rings or holding devices may be present in the socket for leakproofing and clamping of any tank-filler neck, which has to be inserted.

A further improvement can be achieved if one weld partner is corrugated. For example, starting from the solution shown in FIG. 2, the wall of the multilayer fuel tank may, where it is in contact with the cone, have been drawn down and, together with this, corrugated. This has the advantage that during welding, material is ablated at the peaks of the corrugations, this ablated amount being taken up by the valleys of the corrugations. By virtue of the ablation of material, the barrier layer of the tank is reached at at least some locations, the result being a still further reduction in the gap between the barrier layer of the tank and the barrier layer of the cone.

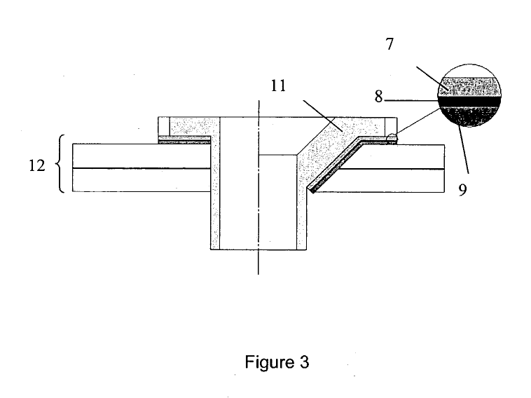

Another example which may be mentioned is the connection of a threaded flange (11), e.g. for fastening the pump unit to the tank (12) (FIG. 3). The threaded flange may either, as shown here, be composed of an unreinforced or glassfiber-reinforced polybutylene terephthalate, or be composed of a polyamide, where appropriate fiber-reinforced. The structure of the coextrudate (7; 8; 9) corresponds to that in FIG. 2. (If the threaded flange is composed of polyamide, the layer (7) is also formed from polyamide.) Depending on the embodiment of the flange (flat or conical), the intermediate coextruded ply is either stamped out (flat) around its periphery from a film or, for example, produced (conically) by thermoforming from a flat film. It is also in accordance with the invention to use other materials, for example polyoxymethylene, polyphthalamide, or polyphenylene sulfide.

To permit conical welding of the partners to one another while still allowing the use of a flat welding surface, it is clear that the elevations present in the tank may be used, serving for stiffening. These are opened by a level cut, whereupon the welding is then carried out at that location. This method further reduces permeation when compared with the embodiment shown in FIG. 1.

The arrangement of layers and the thickness of each of the layers in a particular coextrudate have to be adapted to the requirements placed upon the process of welding or on the process of sheathing by injection molding. Particular success has been achieved by coextruded multilayer composites whose outer layers (i.e. the layers which are bonded to the connecting article or to the attachment) have a thickness of from 0.4 to 1.5 mm. However, other layer distributions are also, of course, within the purview of the present invention.

An underlying principle is that in the attachment and in the hollow article at least the layers to be bonded are composed of a thermoplastic. Any other layers or sections present may, where appropriate, be composed of thermosets or of metal. All of the layers of the coextruded multilayer composite are composed of a thermoplastic molding composition.

Moreover, the present invention may be used to achieve a durable secure bond between attachment and hollow article while at the same time reducing environmentally hazardous emissions.

Another embodiment of the present invention is a method comprising cohesively bonding an attachment to a hollow article, wherein said cohesively bonding comprises contacting the attachment and the hollow article with a coextruded multilayer composite having at least 2 layers therebetween and welding or sheathing in an injection process.

Numerous modifications and variations on the present invention are possible in light of the above teachings. It is, therefore, to be understood that within the scope of the accompanying claims, the invention may be practiced otherwise than as specifically described herein.

What we claim is:

1. A liquid- or vapor-conducting system comprising:
I. an attachment,
II. a jointing zone made from a coextruded multilayer composite which comprising at least two layers,
III. a hollow article,
wherein components I., II., and III. are cohesively bonded to one another.

2. The system according to claim 1, wherein said attachment is selected from the group consisting of an attachment nipple, a threaded neck, a closure cap, a valve, a bayonet closure, a quick connector, a threaded flange, an activated carbon filter, an expansion tank, and a filter housing.

3. The system according to claim 1, wherein said attachment comprises a polymer base which is selected from the group consisting of a polyamide, a polyester, a fluoropolymer, a polyphenylene sulfide, and an aliphatic polyketone.

4. The system according to claim 1, wherein the attachment has a single-layer structure.

5. The system according to claim 1, wherein the attachment has 2 or more layers.

6. The system according to claim 5, wherein the attachment comprises a barrier layer.

7. The system according to claim 5, wherein the attachment comprises an antielectrostatic layer.

8. The system according to claim 1, wherein the coextruded multilayer composite comprises a film, a sheet, a tube, a composite produced by coextrusion blow molding, and a composite produced by coextrusion suction blow molding.

9. The system according to claim 1, wherein the coextruded multilayer composite has been formed prior to connection to the attachment, or prior to connection to the hollow body.

10. The system according to claim 1, wherein the hollow article is a container or a tube.

11. The system according to claim 10, wherein the hollow article is selected from the group consisting of a plastic fuel tank, a container for an activated carbon filter, a stilling reservoir, a filler neck, a fuel line, a brake fluid line, a hydraulic fluid line, and a coolant line.

12. The system according to claim 1, wherein the hollow article has a single-layer structure.

13. The system according to claim 1, wherein the hollow article is composed of 2 or more layers.

14. The system according to claim 13, wherein the hollow article comprises a barrier layer and/or an antielectrostatic layer.

15. The system according to claim 1, wherein the coextruded multilayer composite has 3 or more layers.

16. The system according to claim 1, wherein the outer layers of the coextruded multilayer composite have a thickness ranging from 0.4 to 1.5 mm.

17. A connection unit comprising:
I. an attachment and
II. a coextruded multilayer composite comprising at least two layers,
wherein components I. and II. are cohesively bonded to one another.

18. A composite comprising:
II. a coextruded multilayer composite comprising at least two layers, and
III. a hollow article,
wherein components II. and III. are cohesively bonded to one another.

19. The composite according to claim 18, further comprising an attachment cohesively bonded to components II. and III.

20. A method comprising cohesively bonding an attachment to a hollow article, wherein said cohesively bonding comprises contacting the attachment and the hollow article with a coextruded multilayer composite having at least 2 layers therebetween and welding or sheathing in an injection process.
